(19) United States
(12) Patent Application Publication
(10) Pub. No.: US 2017/0350710 A1
(43) Pub. Date: Dec. 7, 2017

(54) COMPUTER-READABLE RECORDING MEDIUM, METHOD, AND APPARATUS FOR STORING TRAVELING DATA

(71) Applicant: Fujitsu Limited, Kawasaki-shi (JP)

(72) Inventors: Hiroshi Sasaki, Meguro (JP); Hiroyuki Tani, Katsushika (JP); Shin Totoki, Kinosaka (JP)

(73) Assignee: Fujitsu Limited, Kawasaki-shi (JP)

(21) Appl. No.: 15/684,473

(22) Filed: Aug. 23, 2017

Related U.S. Application Data
(63) Continuation of application No. PCT/JP2016/050708, filed on Jan. 12, 2016.

(30) Foreign Application Priority Data
Feb. 26, 2015 (JP) 2015-036901

(51) Int. Cl. G01C 21/28; G01C 21/36

(52) U.S. Cl. CPC G01C 21/28; G01C 21/3667

(57) ABSTRACT

A computer-readable recording medium is disclosed. A computer receives first traveling data, in which latitude and longitude of a vehicle acquired at predetermined time intervals from a departure point to an arrival point are corresponded to time when the latitude and the longitude are acquired. The computer reads out three or more consecutive sets of data of the latitude and the longitude in time from the first traveling data. And, the computer generates second traveling data by control through deleting data existing within a predetermined range from a straight line connecting two points at both ends of the three or more consecutive sets of data of the latitude and the longitude in time. Then, computer stores the generated second traveling data in a storage device.

### CROSS-REFERENCE TO RELATED APPLICATIONS

This application is a U.S. continuation application filed under 35 USC 111(a) claiming benefit under 35 USC 120 and 365(c) of PCT application PCT/JP2016/050708, filed on Jan. 12, 2016, which claims priority to Japanese Patent Application Ser. No. 2015-036901, filed in Japan on Feb. 26, 2015. The foregoing applications are hereby incorporated herein by reference.

### FIELD

The embodiment discussed herein is related to a computer-readable recording medium, method, and apparatus for storing traveling data.

### BACKGROUND

Conventionally, as part of maintenance and repair of roads, a technology has been known to travel on the road with a mobile device mounted on a survey vehicle that investigates a state of a road surface and the like, and to render a route traveled on a map according to position information collected by the mobile device at predetermined time intervals.

[Patent Document 1]

Japanese Laid-open Patent Publication No. 2011-53226

### SUMMARY

According to one aspect of the embodiment, there is provided a non-transitory computer-readable recording medium that stores a traveling data storing program that causes a computer to execute a process including: receiving first traveling data, in which data of latitude and longitude of a vehicle acquired at predetermined time intervals from a departure point to an arrival point correspond to time when the data of the latitude and the longitude are acquired; reading out three or more consecutive sets of data of the latitude and the longitude in time from the first traveling data; generating second traveling data by control through deleting data existing within a predetermined range from a straight line connecting two points at both ends of the three or more consecutive sets of data of the latitude and the longitude in time; and storing the generated second traveling data in a storage device.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating an example of a traveling data storing system;

FIG. 2 is a first diagram for briefly explaining a process for thinning point data of points other than a start point and an end point on a straight line portion;

FIG. 3 is a second diagram for briefly explaining the process of thinning the point data of the points other than the start point and the end point on a straight line portion;

FIG. 4 is a diagram illustrating an example of a hardware configuration of a traveling data storing server;

FIG. 5 is a diagram illustrating an example of a traveling data database;

FIG. 6 is a diagram for explaining functions of the traveling data storing server;

FIG. 7A and FIG. 7B are diagrams for explaining a relationship between a distance from the straight line connecting the start point and the end point to a middle point among three points and an absolute value of a calculation result of a straight line formula;

FIG. 8 is a flowchart for explaining operations of the traveling data storing server;

FIG. 9 is a diagram for explaining the operation of the traveling data storing server;

FIG. 10 is a diagram illustrating an example of a rendering traveling database for rendering; and

FIG. 11 is a flowchart for explaining a process conducted by the rendering process part.

### DESCRIPTION OF EMBODIMENTS

In a related art, when rendering a traveling route, since all sets of position information acquired by a mobile device are used, a load of a rendering process is high.

Therefore, in one aspect, it is an object to provide a computer-readable recording medium, method, and apparatus for reducing a processing load when rendering a route.

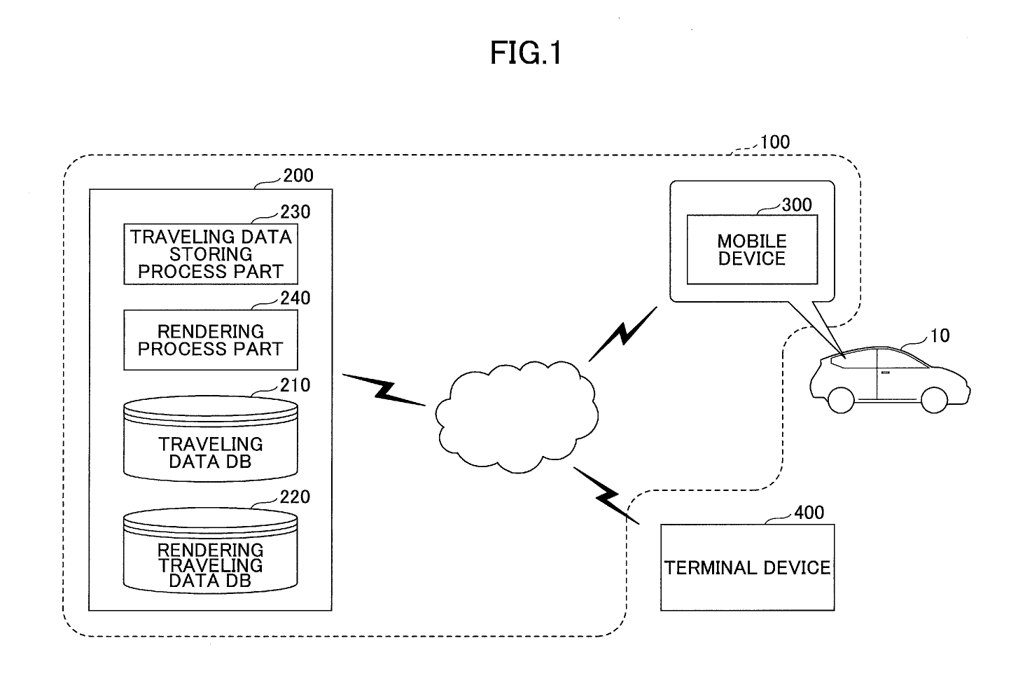

In the following, embodiments of the present invention will be described with reference to the accompanying drawings. FIG. 1 is a diagram illustrating an example of a traveling data storing system.

A traveling data storing system 100 in the present embodiment includes a traveling data storing server 200, and a mobile device 300. The traveling data storing server 200 is connected to the mobile device 300 through a network or the like.

The traveling data storing server 200 in the present embodiment includes a traveling database 210, a rendering traveling database 220, a traveling data storing process part 230, and a rendering process part 240.

For instance, the mobile device 300 in the present embodiment is mounted in a vehicle 10 or the like for surveying a road state while traveling on a road, and acquires location information of the vehicle 10 at predetermined time intervals. Next, the mobile device 300 sends a set of point data in which the location information corresponds to time when the location information is acquired, to the traveling data storing server 200. The location information in the present embodiment is indicated by latitude and longitude, and is acquired by a Global Positioning System (GPS) including the mobile device 300.

The traveling data storing server 200 in the present embodiment stores the traveling data when receiving the traveling data from the mobile device 300.

Also, the traveling data storing server 200 in the present embodiment thins out the point data of points other than a start point and an end point on a straight line portion on the traveling route from the traveling data stored in the traveling database 210. Then, the traveling data storing server 200 stores a set of remaining point data, which have not been excluded (deleted) in this process, as rendering traveling data in the rendering traveling database 220.

In other words, the traveling data storing server 200 in the present embodiment generates second traveling data by deleting the point data of points other than the start point and the end point on a straight line on the traveling route from first traveling data being received, and stores the second traveling data in the rendering traveling database 220.

Accordingly, in the present embodiment, the rendering traveling data are reduced in data amount relative to the traveling data.

Also, the traveling data storing server 200 in the present embodiment receives a display request of the traveling route of the vehicle 10 from a terminal device 400, and has a rendering process part 240 refer to the rendering traveling database 220. The rendering process part 240 generates screen data for a screen on which the traveling route is rendered on a map, based on the rendering traveling database 220, and sends the generated screen data to the terminal device 400.

That is, in the present embodiment, when rendering the traveling route, a rendering process is conducted based on the rendering traveling data in which the data amount of the traveling data is reduced. Hence, according to the present embodiment, it is possible to reduce the data amount to be read for the rendering process. Furthermore, in order to conduct the rendering process by reduced data, it is possible to reduce the load of the rendering process.

In the example depicted in FIG. 1, the terminal device 400 is not included in the traveling data storing system 100; however, the terminal device 400 may be included in the traveling data storing system 100.

Moreover, in the example depicted in FIG. 1, a destination to send the screen data in which the traveling route is rendered is, but is not limited to, the terminal device 400. For instance, in a case of receiving the display request of the traveling route of the vehicle 10 from the mobile device 300, the traveling data storing server 200 may send the screen data to the mobile device 300 or may display a screen rendering the traveling route on a display device of the traveling data storing server 200.

Also, in the example depicted in FIG. 1, the traveling data storing server 200 receives the traveling data from the mobile device 300; however, the present embodiment is not limited thereto. Alternatively, for instance, the traveling data storing server 200 in the present embodiment may read out the traveling data from a recording medium or the like storing the traveling data acquired by the mobile device 300.

Also, in the example depicted in FIG. 1, the rendering process part 240 is provided in the traveling data storing server 200; however, the present embodiment is not limited thereto. Alternatively, for instance, the mobile device 300 or the terminal device 400 may include the rendering process part 240. In such a case, for instance, the traveling data storing server 200 may instruct the rendering process part 400 to refer to the rendering traveling database 220 upon receiving the display request of the traveling route of the vehicle 10.

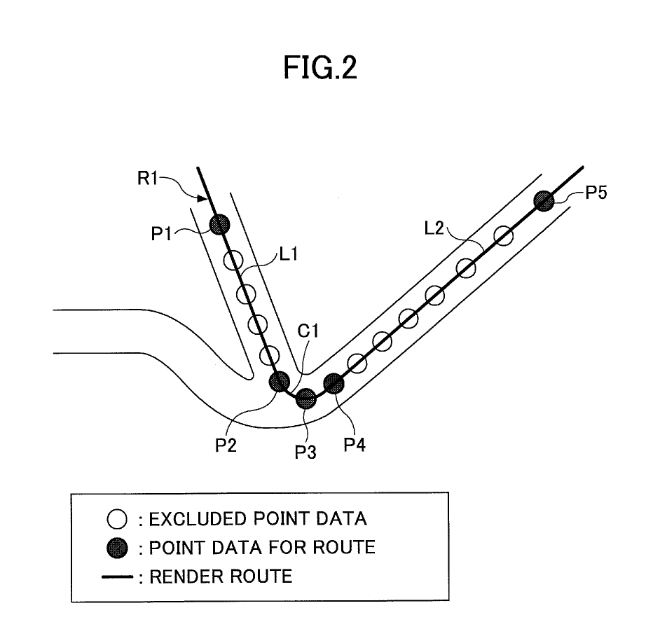

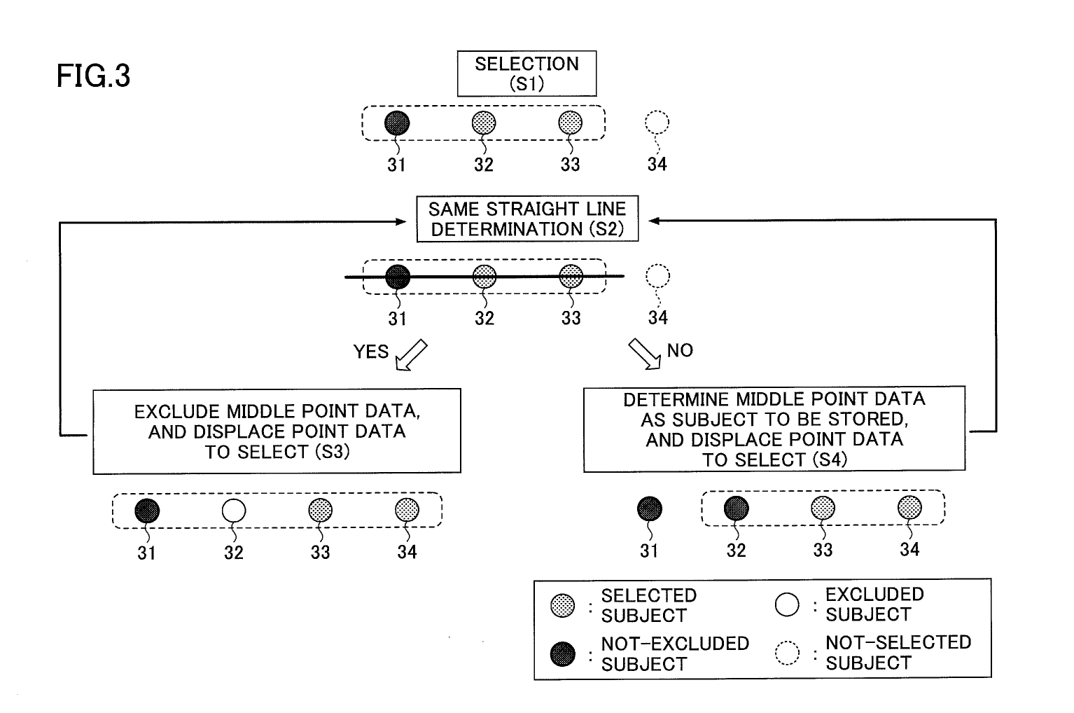

In the following, with reference to FIG. 2 and FIG. 3, a process for thinning the point data of the points other than the start point and the end point on the straight line portion will be described.

FIG. 2 is a first diagram for briefly explaining the process for thinning the point data of the points other than the start point and the end point on the straight line portion.

In the present embodiment, the traveling route is rendered by using only the point data of the start point and the point data of the end point on a straight line, and the point data of points representing a curve, in the traveling data stored in the traveling database 210.

In the example depicted in FIG. 2, a traveling route R1 includes a straight line L1, a curve C1, and a straight line L2. In this case, in the present embodiment, the point data of points between a start point P1 and an end point P2 on the straight line are excluded. Also, in the present embodiment, the point data of a point P3 between a start point P2 of the curve C1 and an end point P4 of the curve C1 are not excluded. In the present embodiment, the same manner is applied to a straight line L2, and the point data of points between the start point P4 and the end point P5 of the straight line L2.

Accordingly, the point data of points P1, P2, P3, P4, and P5 are regarded as the rendering traveling data for the traveling route R1 illustrated in FIG. 2. Regarding the point data of points P1 to P5, the point data of points between the point P1 and the point P2 and the point data of points between the point P4 and the point P5 are excluded.

FIG. 3 is a second diagram for briefly explaining the process of thinning the point data of the points other than the start point and the end point on a straight line portion.

The traveling data storing server 200 in the present embodiment selects three sets of the point data from the traveling database 210 (step S1). The three sets of the point data selected in step S1 are the point data of a point 31 indicated by n-th location information, the point data of a point 32 indicated by n+1-th location information, and the point data of a point 33 indicated by n+2-th location information, which are acquired by the mobile device 300.

In the following, the point data, in which an order of acquiring the location information is continuous, are called “consecutive point data”. In the present embodiment, among three consecutive sets of the point data, the point data of the point 31 that is the start point are set as point data for a not-excluded subject. The point data of a not-excluded subject correspond to point data that are confirmed as being stored in the rendering traveling database 220.

Successively, the traveling data storing server 200 determines whether three selected points are on the same straight line (step S2).

In step S2, in a case in which the three points are on the same straight line, the traveling data storing server 200 determines the point data of the point 32 located in the middle among the three points 31, 32, and 33, as an excluded subject. Next, the traveling data storing server 200 selects a point 34 continuous from the point 33, and goes back to step S2 (step S3). In the present embodiment, the point data determined as an excluded subject are not stored in the rendering traveling database 220.

In step S2, in a case in which the three points are not on the same straight line, the traveling data storing server 200 determines the point data of the point 32 as point data for a not-excluded subject. Then, the traveling data storing server 200 selects three consecutive points 32, 33, and 34 with the point 32 as the start point, and goes back to step S2 (step S4).

By repeating this process, the traveling data storing server 200 in the present embodiment creates the rendering traveling database 220, which excludes the point data other than the start point and the end point on the straight line from the traveling data.

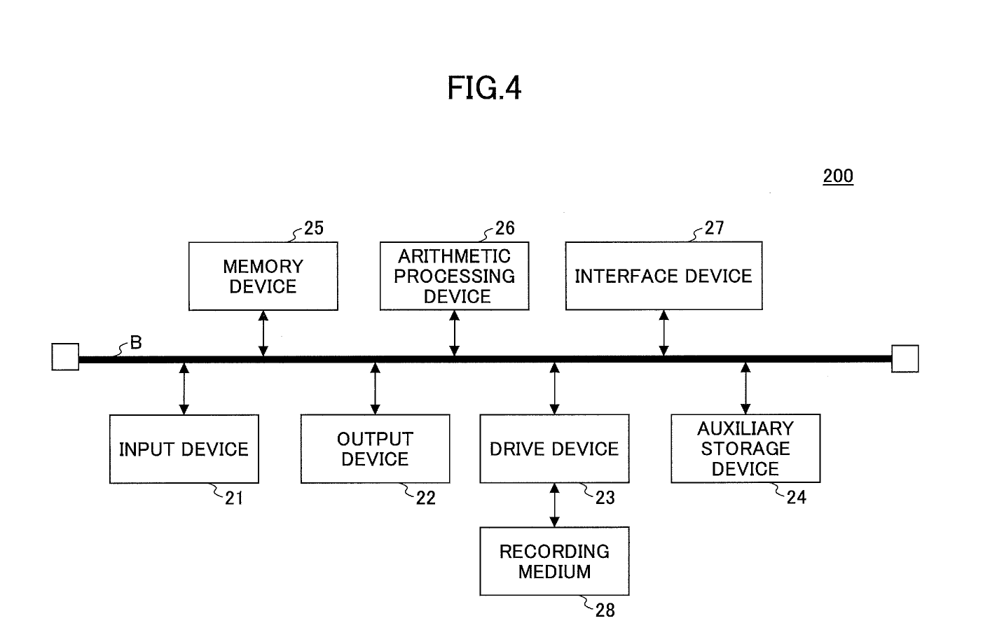

Next, referring to FIG. 4, a hardware configuration of the traveling data storing server 200 in the present embodiment will be described. FIG. 4 is a diagram illustrating an example of a hardware configuration of the traveling data storing server.

The traveling data storing server 200 in the present embodiment includes an input device 21, an output device 22, a drive device 23, an auxiliary storage device 24, a memory device 25, a processor as an arithmetic processing unit 26, and an interface device 27, which are mutually connected via a bus B.

The input device 21 includes a keyboard, a mouse, and the like, and is used to input various signals. The output device 22 includes a display device, or the like, and is used to display various windows, data, and the like. The interface device 27 includes a modem, a Local Area Network (LAN), or the like, and is used to connect to the network.

A traveling data storing program is at least a part of various programs controlling the traveling data storing server 200. For instance, the traveling data storing program may be provided by distributing a recording medium 28 or by being downloaded through the network. As the recording medium 28 recording the traveling data storing program, various types of recording media may be used: a recording medium optically, electrically, or magnetically recording information such as a Compact Disc Read only memory (CD-ROM), a flexible disc, an magnetic optical disk, or the like, a semiconductor memory such as a Read-Only Memory (ROM), a flash memory, or the like. That is, the recording medium 28 may be any type of a recording medium, which is a non-transitory tangible computer-readable medium including a data structure.

Also, when the recording medium 28 recording the traveling data storing program is set to the drive device 23, the traveling data storing program is installed to the auxiliary storage device 24 through the drive device 23 from the recording medium 28. The traveling data storing program downloaded through the network is installed to the auxiliary storage device 24 via the interface device 27.

The auxiliary storage device 24 stores files, data, and the like as well as the installed traveling data storing program. The memory device 25 reads out and stores the traveling data storing program from the auxiliary storage device 24 when the computer that is the traveling data storing server 200 is activated. Then, the arithmetic processing unit 26 realizes various processes described later, in accordance with the traveling data storing program stored in the memory device 25.

Also, for instance, the mobile device 300 and the terminal device 400 in the present embodiment may be general computers, tablets, or the like; hardware configurations thereof may be the same as that of the traveling data storing server 200. In a case in which the mobile device 300 is a tablet, a smart phone, or the like, the mobile device 300 may include a display operation device including a display function, instead of the input device 21 and the output device 22.

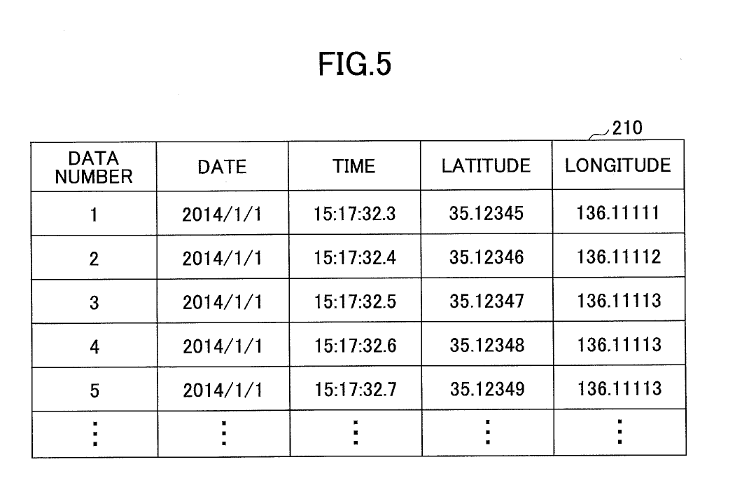

FIG. 5 is a diagram illustrating an example of the traveling data database. The traveling database 210 is provided to correspond to the vehicle 10, and identification information or the like is used to specify the vehicle 10. Accordingly, when receiving the traveling data for multiple vehicles, the traveling data storing server 200 includes a number of sets of the traveling database 210 matching a number of the multiple vehicles.

For instance, the traveling database 210 may be provided in the auxiliary storage device 24 or the like of the traveling data storing server 200.

The traveling database 210 in the present embodiment includes information items of “DATA NUMBER”, “DATE”, “TIME”, “LATITUDE”, “LONGITUDE”, and the like. In the present embodiment, a value of the item “DATA NUMBER” corresponds to a value of other items. In the following, information including the value of the item “DATA NUMBER” and values of the other items may be simply called “point data”. Moreover, in the following, a pair of the items “LATITUDE” and “LONGITUDE” may be called “location information”. That is, the point data include the location information.

The value of the item “DATA NUMBER” is regarded as an identification for specifying the point data. A value of the item “DATE” indicates a date when values of the items “LATITUDE” and “LONGITUDE” are acquired. A value of the item “TIME” indicates a time when the values of the items “LATITUDE” and “LONGITUDE” are acquired. The values of the items “LATITUDE” and “LONGITUDE” indicate the latitude and the longitude acquired by the mobile device 300 at predetermined time intervals.

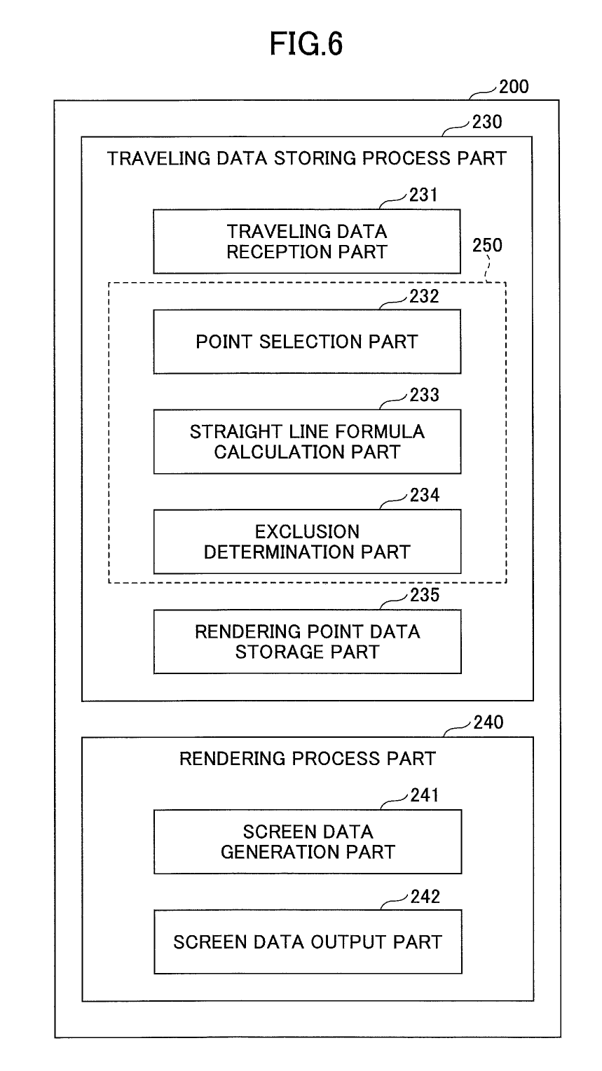

FIG. 6 is a diagram for explaining functions of the traveling data storing server. The traveling data storing server 200 in the present embodiment includes the traveling data storing process part 230 and the rendering process part 240. The traveling data storing process part 230 in the present embodiment is realized by the arithmetic processing unit 26 of the traveling data storing server 200 executing the traveling data storing program. For instance, the rendering process part 240 is realized by the arithmetic processing unit 26 of the traveling data storing server 200 executing a rendering program.

The traveling data storing process part 230 in the present embodiment includes a traveling data reception part 231, a point selection part 232, a straight line formula calculation part 233, an exclusion determination part 234, and a rendering point data storage part 235.

The traveling data reception part 231 in the present invention receives an input of the traveling data and stores the traveling database 210.

The point selection part 232 refers to the traveling database 210, and selects three points to be subjects for a determination process conducted by the exclusion determination part 234 described later, sequentially from a point to be the start point (a departure point) of the traveling route indicating the traveling data.

The straight line formula calculation part 233 acquires the location information of three points selected by the point selection part 232, and calculates values in order to determine whether the three points are on the same straight line. The exclusion determination part 234 determines whether the point data of the point in the middle of three points are to be the excluded subject or the not-excluded subject, based on the calculated values.

That is, the point selection part 232, the straight line formula calculation part 233, and exclusion determination part 234 in the present embodiment serve as a generation part 250. The straight line formula calculation part 233 and the exclusion determination part 234 will be described later.

The rendering point data storage part 235 stores the point data of points, which are determined as not-excluded subjects by the exclusion determination part 234.

The rendering process part 240 in the present embodiment includes a screen data generation part 241, and a screen data output part 242. When receiving the display request of the traveling route of the vehicle 10, the screen data generation part 241 in the present embodiment refers to the rendering traveling database 220, and generates the screen data for the screen in which the traveling route of the vehicle 10 is rendered on the map.

The screen data output part 242 sends the screen data generated by the screen data generation part 241 to a device sending the display request of the traveling route.

In the following, processes of the straight line formula calculation part 233 and the exclusion determination part 234 in the present embodiment will be described.

For a case with coordinates (Xa, Ya) of a point A, coordinates (Xb, Yb) of a point B, and coordinates (Xc, Yc) of a point C, if the following formula (1) is satisfied:

Ya(Xb−Xc)+Yb(Xc−Xa)+Yc(Xa−Xb)=0 (1),

the three points A, B, and C are mathematically determined as being on the same straight line. In order to determine that the three points A, B, and C are on the same straight line, the above formula (1) may be a necessary and sufficient condition.

In the present embodiment, the formula (1) is called “straight line formula”. For the formula (1), it is assumed that an X-axis and a Y-axis have scale units, grid lines are drawn according to scale units of the X-axis and the Y-axis, and lattices in a coordinate plane form squares.

However, in the present embodiment, the latitude and the longitude are used as coordinate axes. Hence, a length per latitude of 1 degree and a length per longitude of 1 degree may not be the same. That is, in a case of using the latitude and the longitude as coordinate axes, the lattices in the coordinate plane are often not squares; accordingly, generally, a calculation result of the straight line formula does not become 0.

Moreover, in the present embodiment, it is assumed to determine whether the traveling route of the vehicle 10 is the straight line. For instance, in this determination, even in a case in which the traveling route of the vehicle 10 is meandering due to a lane change, it is preferable to regard the traveling route as the straight line as long as a meandering width is within a road width.

In the present embodiment, in consideration of these points, based on a relationship between a distance from a straight line connecting the start point and the end point to a middle point among the three points and an absolute value of the calculation result of the straight line formula, a threshold, which is used to determine whether the three points are on the same straight line, is defined. Accordingly, in the present embodiment, when the absolute value of the calculation result of the straight line formula is less than or equal to the threshold, the three points are regarded as being on the same straight line.

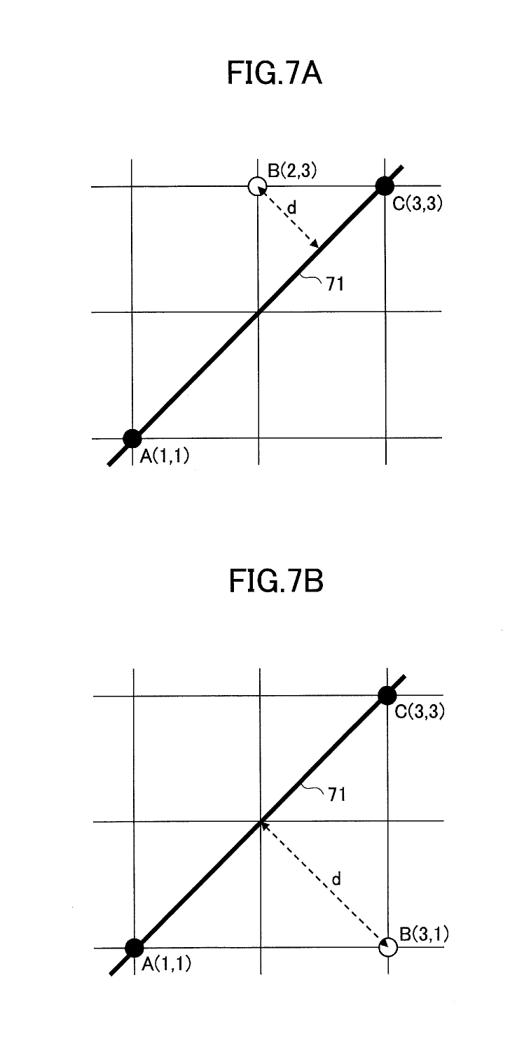

FIG. 7A and FIG. 7B are diagrams for explaining the relationship between the distance from the straight line connecting the start point and the end point to the middle point among three points and the absolute value of the calculation result of the straight line formula. In the example depicted in FIG. 7A and FIG. 7B, the lattices on the coordinate plane form the squares.

FIG. 7A illustrates an example of a case in which the point A is located at coordinates (1, 1), the point B is located at coordinates (2, 3), and the point C is located at coordinates (3, 3).

In this case, with an absolute value of the calculation result of the straight line formula being defined as β, the absolute value β of the calculation result of the straight line formula indicates 2. Moreover, a distance d from a straight line 71 connecting the point A and the point C to the point B is √2/2.

Accordingly, the relationship between the absolute value β of the calculation result of the straight line and the distance d is expressed by a formula (2) below:

β=2√2d (2).

FIG. 7B is a diagram illustrating an example of a case in which the point A is located at coordinates (1, 1), the point B is located at coordinate (3, 1), and the point C is located at coordinate (3, 3). In this case, the above formula (2) also indicates the relationship between the absolute value β of the calculation result of the straight line formula and the distance d.

That is, from these examples described above, the relationship between the absolute value β of the calculation result of the straight line formula and the distance d is represented by the above formula (2).

Accordingly, in the present embodiment, by setting the distance d, the threshold is determined with respect to the absolute value β of the calculation result of the straight line formula.

For instance, when the distance d=1[m], the absolute value β of the calculation result of the straight line formula=2.8 (rounded down to two decimal places). Accordingly, in the present embodiment, in a case in which the middle point of the three points is located within a width 2 [m] from the straight line connecting the start point and the end point of the three points defined as a center, in order to determine that the three points are on the same straight line, the threshold may be defined as 2.8 [m] with respect to the absolute value β of the calculation result of the straight line formula.

In this case, in the present embodiment, if the absolute value β of the calculation result of the straight line formula is less than or equal to 2.8 [m], the three points are determined as being on the same straight line.

Moreover, for instance, in a case of detecting the straight line portion from the traveling route without consideration of the lane change in a straight road including two lanes on each side, in which each of the lanes is 3.5 m in width, d=3.5 may be defined and the threshold may be defined as 9.9 with respect to the absolute value β of the calculation result of the straight line formula.

As described above, in the present embodiment, in a case of the middle point of the three points being within a predetermined range from the straight line connecting the start point and the end point, these three points are determined as being on the same line, and the point data of the middle point is regarded as the excluded subject. Moreover, in the present embodiment, in a case in which the middle point is out of the predetermined range from the straight line connecting the start point and the end point, it is determined that these three points are not on the same straight line and the point data of the middle point is set as the not-excluded subject.

In other words, when the absolute value β of the calculation result of the straight line formula calculated by the straight line formula calculation part 233 is less than or equal to the threshold, the exclusion determination part 234 in the present embodiment determines the three points as being on the same line, and sets the point data of the middle point as the excluded subject. Moreover, when the absolute value β of the calculation result of the straight line formula calculated by the straight line formula calculation part 233 is greater than or equal to the threshold, the exclusion determination part 234 in the present embodiment determines that these three points are not on the same straight line, and sets the point data of the middle point as the not-excluded subject.

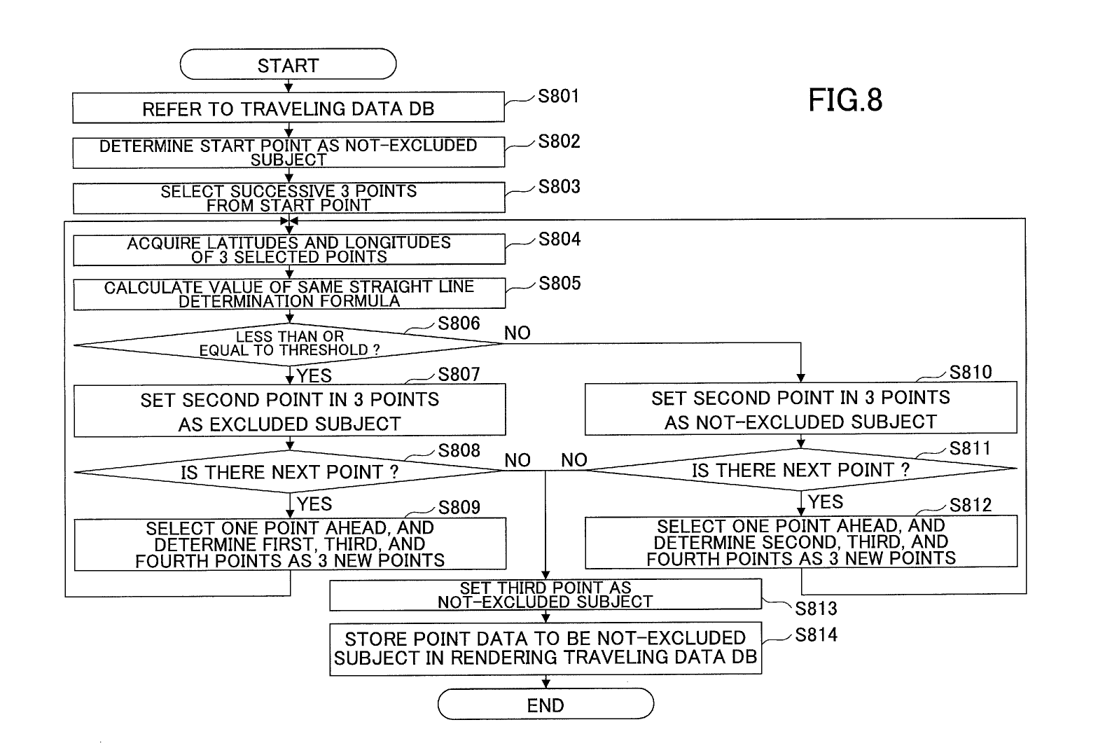

In the following, operations of the traveling data storing server 200 in the present embodiment will be described with reference to FIG. 8.

FIG. 8 is a flowchart for explaining the operations of the traveling data storing server. The traveling data storing server 200 in the present invention refers to the traveling database 210 in which the traveling data received by the traveling data reception part 231 are stored (step S801). Subsequently, the traveling data storing server 200 determines, by the exclusion determination part 234, the point data of a beginning point in the traveling database 210 as the not-excluded subject (step S802). The point data of the beginning point is the point data of the start point of the traveling route.

Next, the traveling data storing server 200 selects, by the point selection part 232, three consecutive points from the beginning in the traveling database 210 (step S803). Successively, the traveling data storing server 200 acquires, by the straight line formula calculation part 233, the location information (the latitude and the longitude) of the three points based on the point data of the selected three points (step S804).

Next, the traveling data storing server 200 substitutes the acquired location information of the three points to the straight line formula, and calculates the absolute value β of the calculation result of the straight line formula (step S805).

Next, the traveling data storing server 200 determines, by the exclusion determination part 234, whether the absolute value β of the calculation result of the straight line formula is less than or equal to the threshold defined beforehand (step S806). In step S806, when the absolute value β is greater than the threshold, the traveling data storing server 200 advances to step S810 described later. In step S806, when the absolute value β is less than or equal to the threshold, the exclusion determination part 234 determines the point data of a second point (the middle point) among the three points, as the point data of the excluded subject (step S807).

Following step S807, the traveling data storing server 200 determines, by the point selection part 232, whether next point data exist in the traveling database 210 (step S808). In step S808, when the next point data do not exist, the traveling data storing server 200 advances to step S813 described later.

In step S808, when the next point data exist, the traveling data storing server 200 selects, by the point selection part 232, one point ahead of a third point among three points selected in step S803, sets a first point, the third point, and a fourth point as new three points (step S809), and goes back to step S804. That is, the point selection part 232 reads out the point data of the fourth point at continuous time, and sets the first point, the third point, and the fourth point as new three points.

In step S806, when the absolute value β is greater than the threshold, the traveling data storing server 200 determines the point data of a second point (the middle point) among the three points as the point data of the not-excluded subject (step S810).

Next, the traveling data storing server 200 determines, by the point selection part 232, whether next point data exist in the traveling database 210 (step S811). In step S811, when next point data do not exit, the traveling data storing server 200 advances to step S813.

In step S811, when next point data exist, the traveling data storing server 200 selects, by the point selection part 232, one point ahead of a third point among the three points selected in step S803, sets a second point, the third point, and a fourth point as new three points (step S812), and goes back to step S804.

In step S808 and step S811, for cases in which next point data do not exist, the traveling data storing server 200 determines, by the exclusion determination part 234, the point data of the third point as the point data of the not-excluded subject (step S813). The point data of the third point in step S813 correspond to the point data of an end of the traveling database 210, that is, the point data of the end point (an arrival point) of the traveling route.

Next, the traveling data storing server 200 stores, by the rendering point data storage part 235, the point data determined as the not-excluded subjects in the rendering traveling database 220 (step S814), and terminates this process.

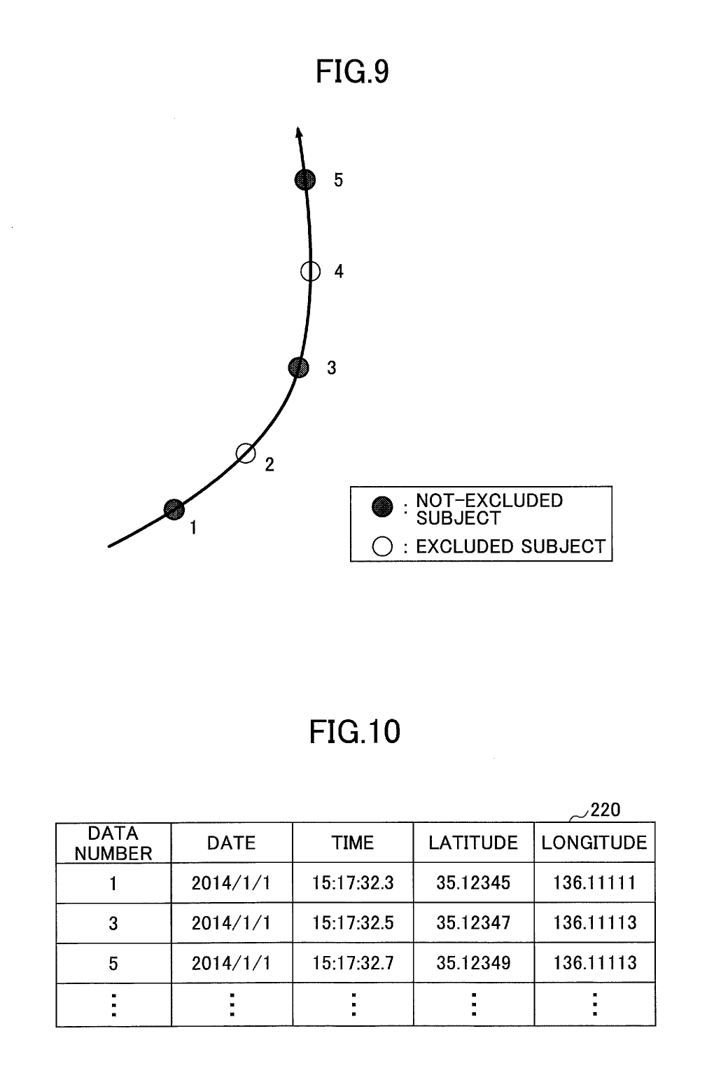

In the following, a process of the traveling data storing server 200 in the present embodiment will be described with reference to FIG. 9 and FIG. 10.

FIG. 9 is a diagram for explaining the operation of the traveling data storing server. The traveling data storing server 200 in the present embodiment determines, by the point selection part 232, the point data of the beginning of the traveling database 210 as the not-excluded subject. The point data of the beginning of the traveling database 210 in the present embodiment correspond to the point data of a data number “1” (refer to FIG. 5). In this case, the point data of the data number “1” correspond to the point data of the start point of the traveling route.

Next, the point selection part 232 selects three sets of the point data from the data number “1” to a data number “3” in the traveling database 210, and acquires a value of the latitude and a value of the longitude from each sets of the point data. Then, the straight line formula calculation part 233 acquires the absolute value β of the calculation result of the straight line formula, and the exclusion determination part 234 determines whether the point data of the data number “2” is to be the not-excluded subject.

In the example illustrated in FIG. 9, a point indicated by the point data of the data number “2” is determined as being on the same straight line as the points indicated by the point data of the data numbers “1” and “3”. Hence, the point indicated by the point data of the data number “2” is determined as the point data for the excluded subject.

Next, the point selection part 232 selects the data number “1”, the data number “3”, and a data number “4” as the next point data after the point data of the data number “3”, conducts a similar process, and determines whether the data number “3” is the excluded subject.

In the example illustrated in FIG. 9, it is determined that the point indicated by the point data of the data number “3” does not exist on the same straight line on which the points indicated by the point data of the data numbers “1” and “4” are located. Hence, the point indicated by the point data of the data number “3” is determined as the point data for the not-excluded subject.

Next, the point selection part 232 selects three sets of the point data sequentially from the point data of the data number “3”, which is determined as the next point data of the not-excluded subject after the data number “1”. Hence, in this case, the point data of the data numbers “3” through “5”.

The traveling data storing server 200 conducts a similar process regarding these three sets of the point data, and determines whether the data number “4” is the excluded subject.

In the example illustrated in FIG. 9, it is determined that the point indicated by the point data of the data number “4” is located on the same straight line on which the points indicated by the point data of the data numbers “3” and “5” exist. Hence, the point data of the data number “4” is determined as the point data of the excluded subject.

In the present embodiment, as described above, it is determined whether each set of the point data stored in the traveling database 210 is the excluded subject. Accordingly, the traveling data storing server 200 in the present embodiment stores the point data determined as the not-excluded subjects in the rendering traveling database 220.

FIG. 10 is a diagram illustrating an example of the rendering traveling database. The rendering traveling database 220 in the present embodiment is provided by corresponding to the traveling database 210. Accordingly, it is preferable for the rendering traveling database 220 to store information indicating a correspondence to the traveling database 210. Also, the rendering traveling database 220 may store identification information of the vehicle 10 included in the traveling database 210, and thus may be associated with the traveling database 210 by the identification information of the vehicle 10.

The rendering traveling database 220 in the present embodiment stores the point data determined as the not-excluded subjects from multiple sets of the point data being stored in the traveling database 210.

In the example illustrated in FIG. 10, the point data of the data number “1” to be the start point of the traveling route, and, as illustrated in FIG. 9 are stored, the data number “3” determined as the not-excluded subject and the point data of the data number “5”.

Also, referring to FIG. 10, the point data of the data number “2” and the data number “4” determined as the excluded subjects are not stored in the rendering traveling database 220. Accordingly, the number of sets of the point data stored in the rendering traveling database 220 is decreased to be less than the number of sets of the point data stored in the traveling database 210. Thus, the data amount is reduced.

The rendering process part 240 in the present embodiment renders the traveling route by referring to the rendering traveling database 220. Compared with the rendering process referring to the traveling database 210, it is possible to reduce load pertinent to the rendering process.

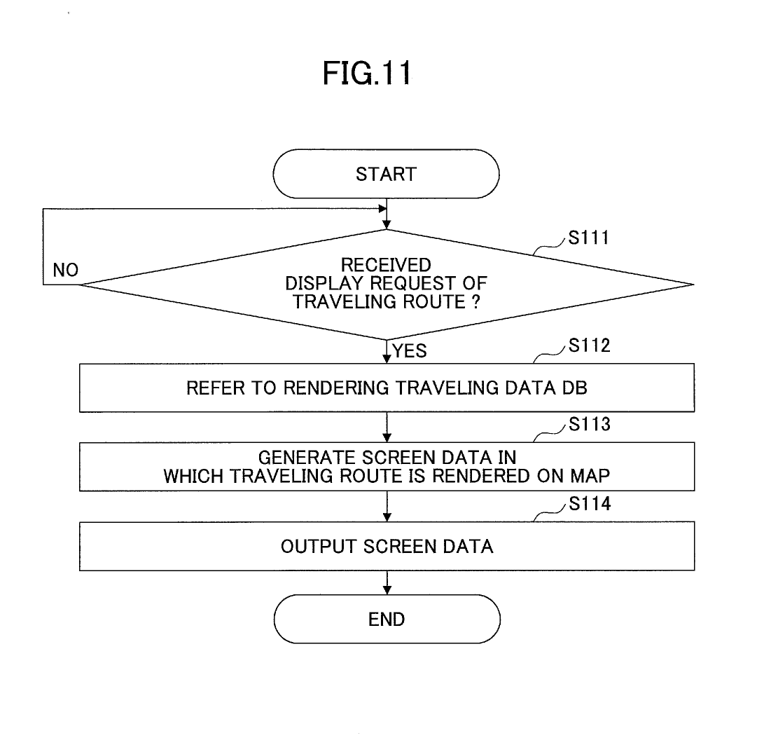

In the following, referring to FIG. 11, the process of the rendering process part 240 in the present embodiment will be described. FIG. 11 is a flowchart for explaining a process conducted by the rendering process part.

The traveling data storing server 200 in the present embodiment determines, by the rendering process part 240, whether the display request of the traveling route of the vehicle 10 is received (step S111). In step S111, when the display request is not received, the traveling data storing server 200 waits until receiving the display request.

In step S111, when receiving the display request, the rendering process part 240 refers to, by the screen data generation part 241, the rendering traveling database 220 corresponding to the vehicle 10 for which the display request of the traveling route is received (step S112).

Next, the rendering process part 240 generates the screen data for the screen rendering the traveling route on a map by using the point data stored in the rendering traveling database 220 (step S113). Map data for displaying the map may be stored in the traveling data storing server 200, or may be acquired from an external server or the like.

Next, the rendering process part 240 outputs, by the screen data output part 242, the generated screen data to a device that sent the display request (step S114), and terminates this process.

As described above, the rendering process part 240 in the present embodiment refers to rendering traveling data, in which the point data of points other than the start point and the end point of a traveling route regarded as the straight line are excluded, based on all sets of the point data acquired by the mobile device 300. Accordingly, it is possible to reduce the data amount to be used, and to reduce the load of the rendering process.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium that stores a traveling data storing program that causes a computer to execute a process comprising:
receiving first traveling data, in which data of latitude and longitude of a vehicle acquired at predetermined time intervals from a departure point to an arrival point correspond to time when the data of the latitude and the longitude are acquired;
reading out three or more consecutive sets of data of the latitude and the longitude in time from the first traveling data;
generating second traveling data by control through deleting data existing within a predetermined range from a straight line connecting two points at both ends of the three or more consecutive sets of data of the latitude and the longitude in time; and
storing the generated second traveling data in a storage device.

2. The non-transitory computer-readable recording medium as claimed in claim 1, wherein the process further comprises:
receiving a display request of a traveling route from the departure point to the arrival point; and
causing a rendering process part that generates screen data for a screen rendering the traveling route to refer to the storage device storing the second traveling data.

3. The non-transitory computer-readable recording medium as claimed in claim 2, wherein the generating of the second traveling data
reads out three consecutive sets of data of the latitude and the longitude in time from the first traveling data;
determines whether a distance from a line connecting the two points at the both ends to a middle point is within the predetermined range, with respect to the three consecutive sets of data of the latitude and the longitude; and
for the distance being within the predetermined range, deletes data of the middle point,
reads out data of the latitude and the longitude acquired next after latest acquired data in the three consecutive sets of data of the latitude and the longitude, and
repeats the determination of the distance with respect to three consecutive sets of data of the latitude and the longitude in which the data of the middle point is excluded.

4. The non-transitory computer-readable recording medium as claimed in claim 3, wherein the generating of the second traveling data, for the distance not being in the predetermined range in the determination process,
reads out three for the distance not being within the predetermined range in the determination process consecutive sets of data of the latitude and the longitude starting from the middle point, which is included in the new three consecutive sets of data, and
repeats the determination process.

5. The non-transitory computer-readable recording medium as claimed in claim 4, wherein the determination of the distance determines that the distance is within the predetermined range, for an absolute value of a calculation result being within a threshold set depending on the distance, the absolute value acquired by substituting the three consecutive sets of data of the latitude and the longitude to a formula representing a necessary and sufficient condition for three points to be on one straight line on a plane.

6. The non-transitory computer-readable recording medium as claimed in claim 5, wherein the generating of the second traveling data includes multiple sets of data of latitudes and longitudes from the departure point to the arrival point into the second traveling data.

7. A traveling data storing method by a computer, comprising:
receiving first traveling data, in which data of latitude and longitude of a vehicle acquired at predetermined time intervals from a departure point to an arrival point correspond to time when the data of the latitude and the longitude are acquired;
reading out three or more consecutive sets of data of the latitude and the longitude in time from the first traveling data;
generating second traveling data by control through deleting data existing within a predetermined range from a straight line connecting two points at both ends of the three or more consecutive sets of data of the latitude and the longitude in time; and
storing the generated second traveling data in a storage device.

8. A traveling data storing apparatus, comprising:
a memory; and
a processor coupled to the memory and the processor configured to:
receive first traveling data, in which data of latitude and longitude of a vehicle acquired at predetermined time intervals from a departure point to an arrival point correspond to time when the data of the latitude and the longitude are acquired;
read out three or more consecutive sets of data of the latitude and the longitude in time from the first traveling data;
generate second traveling data by control through deleting data existing within a predetermined range from a straight line connecting two points at both ends of the three or more consecutive sets of data of the latitude and the longitude in time; and
store the generated second traveling data in a storage device.
